(19) United States
(12) Patent Application Publication
(10) Pub. No.: US 2025/0253337 A1
(43) Pub. Date: Aug. 7, 2025

(54) POSITIVE ELECTRODE BINDER FOR LITHIUM ION BATTERIES

(71) Applicant: SOLVAY SPECIALTY POLYMERS ITALY S.P.A., Bollate (Milano) (IT)

(72) Inventors: Maurizio Biso, Milano (MI) (IT); Francesco Liberale, Pavia (PV) (IT); Riccardo Rino Pieri, Milano (IT); David James Wilson, LA POMAREDE (FR); Guillaume Gody, RUEIL-MALMAISON (FR); Jean-Christophe Castaing, Sèvres (FR)

(73) Assignee: SOLVAY SPECIALTY POLYMERS ITALY S.P.A., Bollate (Milano) (IT)

(21) Appl. No.: 18/856,542

(22) PCT Filed: Apr. 11, 2023
(86) PCT No.: PCT/EP2023/059450

§ 371 Date: Oct. 11, 2024

(30) Foreign Application Priority Data
Apr. 12, 2022 (EP) 22305526.0

(51) Int. Cl. H01M 4/62; C09D 5/24; C09D 7/61; C09D 127/16; H01M 4/04; H01M 4/131; H01M 4/58

(52) U.S. Cl. CPC H01M 4/623; C09D 5/24; C09D 7/61; C09D 127/16; H01M 4/0404; H01M 4/131; H01M 4/5825

(57) ABSTRACT

The present invention pertains to a binder for Li-ion battery positive electrode, to a method of preparation of said electrode and to its use in a Li-ion battery. The invention also relates to the Li-ion batteries manufactured by incorporating said electrode.

### CROSS REFERENCE TO PREVIOUS APPLICATIONS

This application claims priority to European application No. 22305526.0 filed on 16 Apr. 2022, the whole content of this application being incorporated herein by reference for all purposes.

### TECHNICAL FIELD

The present invention pertains to a binder for Li-ion battery positive electrode, to a method of preparation of said electrode and to its use in a Li-ion battery.

The invention also relates to the Li-ion batteries manufactured by incorporating said electrode.

### BACKGROUND ART

Electrochemical devices such as secondary batteries typically comprise a positive electrode, a negative electrode and an electrolyte.

The most critical component of a lithium ion secondary battery is the positive electrode (cathode) material, whose performance affects the overall performance of the lithium ion secondary battery. Various attempts are being made to provide cathode materials having low production costs and large energy capacity while maintaining high-temperature stability.

The conventional active materials at the positive electrode are generally of the LiMO₂ type, of the LiMPO₄ type, of the Li₂MPO₃F type, of the Li₂MSiO₄ type, where M is Co, Ni, Mn, Fe or a combination of these, of the LiMn₂O₄ type or of the S₈ type.

Among these materials, lithium iron phosphate (LiFePO₄ or LFP), having an olivine structure, has attracted attention as a potential cathode material for Li-ion battery due to a high theoretical capacity (170 mA h g⁻¹), high safety and economic benefits.

The electrodes for lithium batteries are usually produced by mixing a binder with a powdery electrode active material.

Fluororesins such as vinylidene fluoride-based polymers have been used as binders for forming positive electrodes. In particular, polyvinylidene fluoride (PVDF) provides a good electrochemical stability and high adhesion to the electrode materials and to current collectors. PVDF is therefore a preferred binder material for electrode slurries.

US 2018/0355206 discloses the use of a copolymer of methyl methacrylate and methacrylic acid in admixture with PVDF for the preparation of LiNMC electrode slurries having good adhesion to the current collector; said mixture has a viscosity that makes it possible to easily spread the active substance over the metal current collector, thus facilitating the manufacture of an electrode for a lithium ion battery.

US 2015/0280238 discloses a stable electrode binder dispersion for use in the preparation of LFP cathodes for lithium ion battery, said dispersion comprising a PVDF dispersed in an organic diluent and a (meth)acrylic polymer dispersant.

Modified polar PVDF polymers, such as those comprising recurring units derived from hydrophilic (meth)acrylic monomers (e.g. acrylic acid), are well known in the art. Such copolymers have been developed aiming at adding to the mechanical properties and chemical inertness of PVDF suitable adhesion towards metals, e.g. aluminium or copper.

However, modified polar PVDF polymers when used in the preparation of a slurry for forming positive electrodes with LiFePO₄ active material, have an important drawback, in that the slurry often undergoes to a rapid viscosity increase, leading to the formation of a gel, thus preventing their use as binder for LPF cathodes.

The present invention provides a positive electrode-forming composition comprising LFP active material capable of preventing gelation while, at the same time, enabling the manufacturing of electrodes having enhanced adhesion and electrochemical stability.

### SUMMARY OF INVENTION

It is thus an object of the invention a positive electrode-forming composition (C) comprising at least one positive electrode active material (AM) having an olivine structure and one binder (B), wherein binder (B) comprises, preferably consists of:
a) at least one vinylidene fluoride (VDF) copolymer [polymer (F)] that comprises:
   (i) recurring units derived from VDF;
   (ii) recurring units derived from at least one hydrophilic (meth)acrylic monomer (MA) of formula (I):

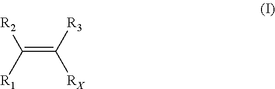

wherein:
   R₁, R₂ and R₃, equal to or different from each other, are independently selected from a hydrogen atom and a C₁-C₃ hydrocarbon group, and
   Rₓ is a C₁-C₂₀ hydrocarbon moiety comprising at least one functional group selected from a hydroxyl, a carboxyl, an epoxide, an ester and an ether group,
in an amount of from 0.05 to 10% by moles of with respect to the total moles of recurring units of polymer (F);
b) at least one a (meth)acrylic polymer [polymer (A)];
c) at least one solvent (S); and
d) optionally at least one electroconductivity-imparting additive.

In a second instance, the present invention pertains to the use of the electrode-forming composition (C) of the invention in a process for the manufacture of a positive electrode for electrochemical devices [electrode (E)], said process comprising:
(i) providing a metal substrate having at least one surface;
(ii) providing an electrode-forming composition (C) as defined above;
(iii) applying the composition (C) onto the at least one surface of the metal substrate, thereby providing an assembly comprising a metal substrate coated with said composition (C) onto the at least one surface;
(iv) drying the assembly provided in step (iii).

In a third instance, the present invention pertains to the positive electrode (E) obtainable by the process of the invention.

In a fourth instance, the present invention pertains to an electrochemical device comprising a positive electrode (E) of the present invention.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

The terms “acrylic” and “acrylate” are used interchangeably (unless to do so would alter the intended meaning) and include acrylic acids and derivatives thereof. The terms “(meth)acrylic” or “(meth)acrylate” are intended to cover both the acrylic/acrylate and methacrylic/methacrylate forms of the indicated material, e.g., a (meth)acrylate monomer.

The active material (AM) having an olivine structure is a compound having the following formula:

LiₓA_{y}D_{z}PO₄,
wherein A is selected from the group consisting of Mn, Fe, Co, Ni and Cu; D is selected from the group consisting of Mg, Ca, Sr, Ba; x, y and z are numbers that satisfy the following relationships: 0<x<2, 0<y<1.5, 0≤z<1.5.

The A component is preferably Fe, Mn, and Ni, and particularly preferably Fe.

The D component is preferably Mg or Ca.

Examples of the compound having an olivine structure include lithium iron phosphate (LFP) and lithium manganese phosphate.

Further, as the positive electrode active material (AM), it is possible to use a material whose surface is partially or wholly covered with carbon in order to supplement the conductivity.

The amount of carbon coated is preferably 20 parts by weight or less, more preferably 10 parts by weight or less, still more preferably 5 parts by weight or less, based on 100 parts by weight of the positive electrode active material.

The compound having an olivine structure is present in composition (C) in an amount of 70% by mass or more, with respect to 100% by mass of the entire positive electrode active material (AM).

More preferably, it is 90% by mass or more, and most preferably, the positive electrode active material (AM) is composed only of a compound having an olivine structure.

Most preferably, the positive electrode active material (AM) consists only of lithium iron phosphate (LFP).

In the positive electrode composition of the present invention, the active material (AM) has an average particle size of 1 μm or less.

The average particle size of the compound having an olivine structure is more preferably 0.01 to 0.8 μm.

The average particle size of the positive electrode active material can be measured by a particle size distribution meter for dynamic light scattering

As the average particle size becomes smaller, the surface area becomes larger and the binder must be bound with a small amount of the binder, so that the flexibility of the binder is required.

By using a positive electrode active material containing a compound having an olivine structure having an average particle size of 1 μm or less, the electrical characteristics such as the output characteristics when the positive electrode composition for a secondary battery is used as the positive electrode of the battery are excellent.

Composition (C) of the invention further comprises binder (B) comprising, preferably consisting of:
a) at least one vinylidene fluoride (VDF) copolymer [polymer (F)]
b) at least one a (meth)acrylic polymer [polymer (A)];
c) at least one solvent (S); and
d) optionally at least one electroconductivity-imparting additive.

The polymer (F) comprises recurring units derived from vinylidene fluoride (VDF) and recurring units derived from at least one hydrophilic (meth)acrylic monomer (MA) of formula (I):

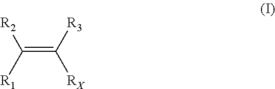

wherein:
   R₁, R₂ and R₃, equal to or different from each other, are independently selected from a hydrogen atom and a C₁-C₃ hydrocarbon group, and
   Rₓ is a C₁-C₂₀ hydrocarbon moiety comprising at least one functional group selected from a hydroxyl, a carboxyl, an epoxide, an ester and an ether group,
in an amount of from 0.05 to 10% by moles of with respect to the total moles of recurring units of polymer (F).

The term “hydrophilic (meth)acrylic monomer” as employed herein may comprise recurring units derived from one or more than one hydrophilic (meth)acrylic monomer (MA) as above described. In the rest of the text, the expressions “hydrophilic (meth)acrylic monomer (MA)” is to be intended, both in the plural and the singular, that is to say that they denote both one or more than one hydrophilic (meth)acrylic monomer (MA).

More preferably, the hydrophilic (meth)acrylic monomer (MA) preferably complies with formula (II):

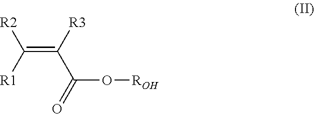

wherein each of R₁ and R₂ have the meanings as above defined, R₃ is hydrogen, and R_{OH} is a hydrogen or a C₁-C₅ hydrocarbon moiety comprising at least one hydroxyl group and/or at least a carboxylic group; more preferably, each of R₁, R₂, R₃ are hydrogen, while R_{OH} has the same meaning as above detailed.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

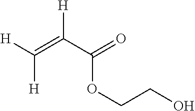

2-hydroxypropyl acrylate (HPA) of either of formulae:

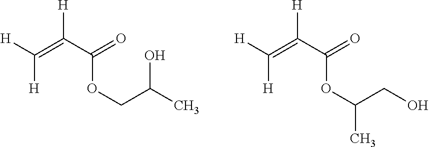

acrylic acid (AA) of formula:

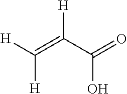

and mixtures thereof.

Most preferably, the monomer (MA) is AA and/or HEA.

Polymer (F) may still comprise other moieties such as defects, end-groups and the like, which do not affect nor impair its physico-chemical properties.

Polymer (F) is semi-crystalline. The term semi-crystalline is intended to denote a polymer (F) which possesses a detectable melting point. It is generally understood that a semi-crystalline polymer (F) possesses a heat of fusion determined according to ASTM D 3418 of advantageously at least 0.4 J/g, preferably of at least 0.5 J/g, more preferably of at least 1 J/g.

Polymer (F) is preferably a linear copolymer, that is to say, it is composed of macromolecules made of substantially linear sequences of recurring units from VDF monomer and (MA) monomer; polymer (F) is thus distinguishable from grafted and/or comb-like polymers.

Polymer (F) comprises at least 0.05% by moles, more preferably at least 0.1% by moles, even more preferably at least 0.2% by moles of recurring units derived from said hydrophilic (meth)acrylic monomer (MA).

Polymer (F) comprises preferably at most 2% by moles, more preferably at most 1.8% by moles, even more preferably at most 1.5% by moles of recurring units derived from said hydrophilic (meth)acrylic monomer (MA).

In a preferred embodiment of the invention, in polymer (F) the recurring units derived from hydrophilic (meth)acrylic monomer (MA) of formula (I) are comprised in an amount of from 0.2 to 1% by moles with respect to the total moles of recurring units of polymer (F).

The polymer (F) has advantageously an intrinsic viscosity, measured in dimethylformamide at 25° C., of above 0.15 I/g and at most 0.60 I/g, preferably in the range of 0.20-0.50 I/g, more preferably comprised in the range of 0.25-0.40 I/g.

The polymer (F) may further comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

In one embodiment of the invention, polymer (F) comprises from 0.1 to 10.0% by moles, preferably from 0.3 to 5.0% by moles, more preferably from 0.5 to 3.0% by moles of recurring units derived from said fluorinated comonomer (CF).

In one preferred embodiment of the invention, the polymer (F) comprises recurring units derived from:
at least 70% by moles, preferably at least 75% by moles, more preferably at least 85% by moles of vinylidene fluoride (VDF),
from 0.2% to 1% by moles, of a hydrophilic (meth)acrylic monomer (MA) of formula (I);
optionally from 0.5 to 3.0% by moles of recurring units derived from at least one fluorinated comonomer (CF).

The polymer (F) may be obtained by polymerization of a VDF monomer, at least one monomer (MA) and optionally at least one comonomer (CF) either in suspension in organic medium, according to the procedures described, for example, in WO 2008/129041, or in aqueous emulsion, typically carried out as described in the art (see e.g. U.S. Pat. Nos. 4,016,345, 4,725,644 and 6,479,591).

The procedure for preparing the polymer (F) in suspension comprises polymerizing in an aqueous medium in the presence of a radical initiator the vinylidene fluoride (VDF) monomer, monomer (MA) and optionally comonomer (CF), in a reaction vessel, said process comprising
continuously feeding an aqueous solution comprising monomer (MA); and
maintaining the pressure in said reactor vessel exceeding the critical pressure of the vinylidene fluoride.

During the whole suspension polymerization run, pressure is maintained above critical pressure of vinylidene fluoride. Generally, the pressure is maintained at a value of more than 50 bars, preferably of more than 75 bars, even more preferably of more than 100 bars.

The expressions “continuous feeding”, “adding continuously” or “continuously feeding” means that slow, small, incremental additions the aqueous solution of hydrophilic (meth)acrylic monomer (MA) take place until polymerization has concluded.

The polymer (F) thus obtained has a high uniformity of monomer (MA) distribution in the polymer backbone, which advantageously maximizes the effects of the modifying monomer (MA) on both adhesiveness and/or hydrophilic behaviour of the resulting copolymer.

In addition, the Applicant has surprisingly found that the presence of the monomer (MA) uniformly distributed in the polymer (F) has the effect of improving the thermal stability of VDF copolymers, which otherwise is unsatisfactorily low, in particular lower than that of VDF homopolymers.

The at least one (meth)acrylic polymer (A), different from polymer (F), is a polymer comprising recurring units derived from at least one (meth)acryloyl monomer (MAM).

Polymer (A) may be a homopolymer or a copolymer. By “copolymer” as used herein it is intended to denote a polymer having two or more different monomer units. The copolymer could be a terpolymer with three or more different monomer units, or have four or more different monomer units. The copolymer may be a random copolymer, a gradient copolymer, or a block copolymer formed by a controlled polymerization process. Preferably, the copolymer is formed by a free radical polymerization process or an anionic polymerization process, and the process can be any polymerization method known in the art, including but not limited to emulsion, solution, suspension polymerization, and can be done in bulk, and semi-bulk.

The term (meth)acryloyl monomer (MAM) refers to the monomer having a (meth)acryloyl group in the molecule.

Suitable (meth)acryloyl monomers (MAM) are hydrophobic (meth)acryloyl monomers that may for example, be chosen from (meth)acrylamide acid esters of formula CH₂═C(R)—C(═O)—NH—Rh, or (meth)acrylic acid esters of formula CH₂═C(R)—C(═O)—O—Rh wherein R means hydrogen or an alkyl group with 1 to 3 carbon atoms and Rh means a linear or branched alkyl residue with 1 to 30 carbon atoms, preferably with 1 to 15 carbons, more preferably with 1 to 5 carbons.

Non-limited examples of such monomers are methyl (meth)acrylate, ethyl (meth)acrylate, n-propyl(meth)acrylate, isopropyl(meth)acrylate, n-butyl (meth)acrylate, methoxy ethyl (meth)acrylate, 2-ethoxy ethyl (meth)acrylate, tert-butyl (meth)acrylate, pentyl(meth)acrylate, heptyl(meth)acrylate, 2-tert-butylheptyl(meth)acrylate, octyl (meth)acrylate), iso-octyl (meth)acrylate, nonyl(meth)acrylate, decyl(meth)acrylate, undecyl(meth)acrylate, 5-methylundecyl(meth)acrylate, dodecyl (meth)acrylate, isobornyl (meth)acrylate, norbornyl(meth)acrylate, cycloalkyl (meth)acrylate, like cyclohexyl(meth)acrylate, phenyl (meth)acrylate.

Polymer (A) may also include recurring units derived from at least one hydrophilic (meth)acryloyl monomer, such as monoethylenically unsaturated monocarboxylic acid and derivatives. This include, among others, acrylic acid, methacrylic acid (MAA), hydroxyethyl(meth)acrylate, hydroxypropyl(meth)acrylate, hydroxyethylhexyl(meth)acrylate, crotonic acid, 2-carboxyethyl acrylate oligomers such as Sipomer®B-CEA.

The expression “methylmethacrylate polymer” is used within the frame of the present invention for designating a polymer made of recurring units, wherein more than 50% by moles of said recurring units being derived from methylmethacrylate (MMA).

Preferred (meth)acrylic polymers (A) for use in composition (C) of the present invention are methylmethacrylate polymers.

In a preferred embodiment of the present invention, polymer (A) is a methylmethacrylate polymer that contains at least 50% by moles of methylmethacrylate monomer units, preferably at least 70% by weight, more preferably at least 80% by moles of methylmethacrylate monomer units.

According to said preferred embodiment, when polymer (A) is a copolymer, it may contain from 1 to 50, preferably 3 to 30, and more preferably 5 to 20% by weight of at least one co-monomer copolymerizable with methylmethacrylate, including but not limited to monomers (MAM) as above defined, or other ethylenically unsaturated monomers.

The (meth)acrylic polymer (A) is prepared by polymerizing a mixture of alpha, beta-ethylenically unsaturated (meth)acryloylc monomers (MAM), optionally in the presence of other alpha, beta-ethylenically unsaturated monomers bearing functionalities such as carboxyl groups or substituted alkyl esters.

According to an embodiment of the present invention, the polymer (A) may further comprise recurring units derived from one or more ethylenically unsaturated monomer carrying an unsaturated heterocyclic group having at least one nitrogen atom [monomer (M1)] having the formula (III) below:

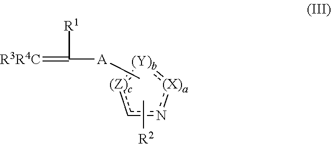

wherein:
R¹ is H or an alkyl group, wherein the alkyl group is preferably a methyl group;
R² is H or an alkyl group;
R³ and R⁴ being the same or different from each other, may be selected from a hydrogen atom or from a linear or branched alkyl group having 1 to 6 carbon atoms;
A is a linkage selected from the group consisting of:
   a single covalent bond; and
   a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond.

The “unsaturated heterocyclic group having at least one nitrogen atom” in monomer (M1) of formula (II) includes preferably a 5- to 6-membered aromatic cyclic group having at least one N in the ring and, such as:

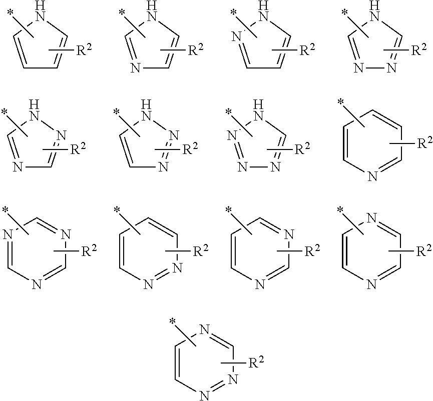

wherein * represent the tie point of the linkage A.

The linkage A and the residue R² may be attached to the heterocyclic group at any position, either on carbon or nitrogen atom.

The monomer (M1) may for example be:

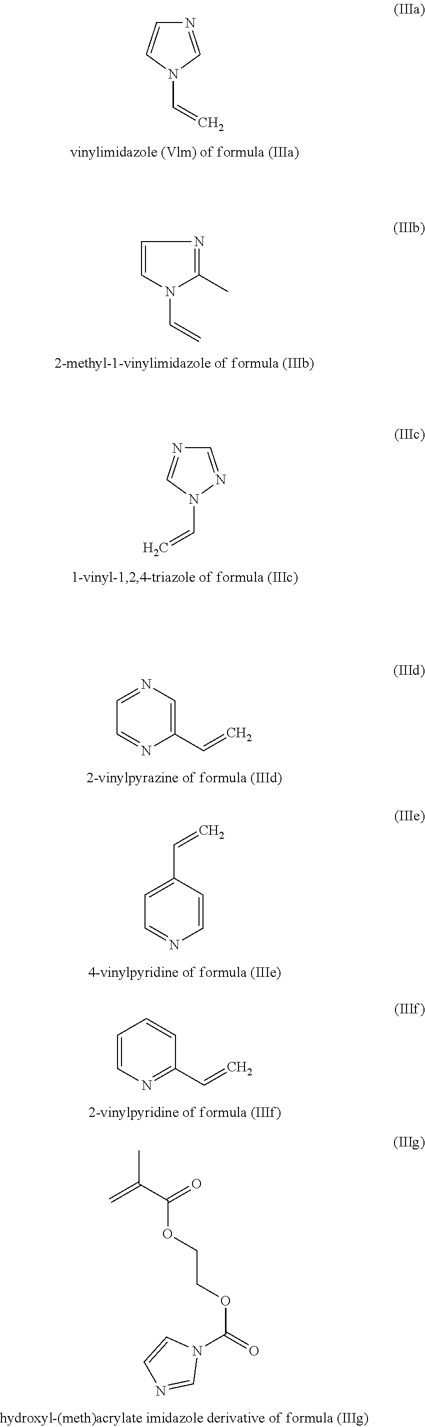

When any of X, Y and Z in formula (III) is a carbon, it may be typically be the carbon of a carbonyl group.

The monomer (M1) may thus for example be:

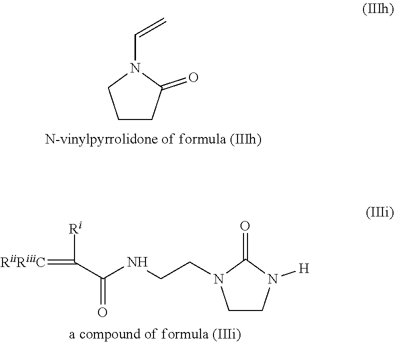

The divalent spacer group A in formula (III) may typically be group —CO—NH—(CH₂)ₙ—, —CO—O—(CH₂)ₙ or —CO—O—(CH₂)ₙ—O—CO—, but any other covalent linker group may be contemplated, for example resulting from the reaction of a compound of formula (III-X):

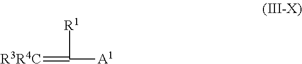

wherein R⁶, R⁸ and R⁹ are as above defined,
with a compound of formula (III-Y):

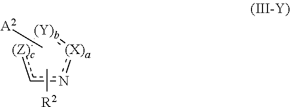

wherein R² is as above defined, A¹ and A² are two groups reacting together for forming a covalent bond.

For example, A² may be a —(CH₂)ₘ—NH₂ group wherein m is from 1 to 4, preferably 2 or 3. In that case, A¹ may be for example a carboxylic acid, an acid chloride, an anhydride or an epoxy.

According to another variant, A² may be a —(CH₂)ₘ—OH group wherein m is from 1 to 4, preferably 2 or 3. In that case, A¹ may be for example a carboxylic acid, an acid chloride, an anhydride or an ester.

When the (meth)acrylic polymer (A) includes hydrophilic (meth)acryloyl monomer such as monoethylenically unsaturated monocarboxylic acid, said polymer (A) may further be at least partially salified to obtain at least a fraction of the acidic moieties in the form of a salt.

In an embodiment of the present invention, it is thus provided a (meth)acrylic polymer (A) that is at least partially salified.

The preparation of (meth)acrylic polymer (A) may thus further include a step of neutralization of at least a fraction of acid groups with a salt [salt (SA)] including a monovalent cation in a suitable solvent.

The salt (SA) can be any salt capable of neutralizing the acid groups, and it is preferably selected from a salt capable of providing an alkali metal cation, a tertiary or quaternary ammonium cation, more preferably Na⁺, K⁺, Li⁺ and or quaternary ammonium cation.

The polymer (A) for use in the composition (C) of the present invention preferably has a number average molecular weight (Mn) of at least 1 kDa, for example between 1 and 150 kDa. More preferably, the polymer (A) has a number average molecular weight (Mn) between 15 and 100 kDa.

The polymer (A) for use in the composition (C) of the present invention preferably has a weight average molecular weight (Mw) of about 1 kDa to 150 kDa, preferably from 5 kDa to 100 kDa.

In one embodiment of the present invention, polymer (A) is a methylmethacrylate polymer comprising 100% by moles of methylmethacrylate monomer units (methylmethacrylate homopolymer).

According to another preferred embodiment, polymer (A) is a methylmethacrylate copolymer comprising at least 80% by moles of methylmethacrylate monomer units and up to 20% by moles of methacrylic acid monomer units.

The choice of the solvent (S) is not particularly limited, provided that it is suitable for solubilising polymer (F) and polymer (A).

Solvent (S) is typically selected from the group consisting of:
alcohols such as methyl alcohol, ethyl alcohol and diacetone alcohol,
ketones such as acetone, methylethylketone, methylisobutyl ketone, diisobutylketone, cyclohexanone and isophorone,
linear or cyclic esters such as isopropyl acetate, n-butyl acetate, methyl acetoacetate, dimethyl phthalate and γ-butyrolactone,
linear or cyclic amides such as N,N-diethylacetamide, N,N-dimethylacetamide, dimethylformamide and N-methyl-2-pyrrolidone, and
dimethyl sulfoxide.

The electrode forming compositions of the present invention may further include one or more optional electroconductivity-imparting additives in order to improve the conductivity of an electrode made from the composition of the present invention. Electroconductivity-imparting additives for batteries are known in the art.

Examples thereof may include: carbonaceous materials, such as carbon black, graphite fine powder carbon nanotubes, graphene, or fiber, or fine powder or fibers of metals such as nickel or aluminum. The optional conductive agents are preferably carbon black or carbon nanotubes.

The amount of optional conductive agent is preferably from 0 to 30% by weight with respect to the total solids in the electrode forming composition. In particular, for positive electrode forming compositions the optional conductive agent is typically from 0% by weight to 10% by weight, more preferably from 0% by weight to 5% by weight of the total amount of the solids within the composition (C).

Composition (C) may further comprise at least one wetting agent and/or at least one surfactant and one or more than one additional additives.

Composition (C) may further comprise at least one non-electroactive inorganic filler material.

By the term “non-electroactive inorganic filler material”, it is hereby intended to denote an electrically non-conducting inorganic filler material, which is suitable for the manufacture of an electrically insulating separator for electrochemical cells.

The non-electroactive inorganic filler material in the separator according to the invention typically has an electrical resistivity (p) of at least 0.1×1010 ohm cm, preferably of at least 0.1×1012 ohm cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

Binder (B) for use in the composition (C) according to the present invention can be prepared by any known method in the art. A suitable method comprises:
dissolving polymer (F) with a solvent (S),
dissolving polymer (A) with a solvent (S), preferably the same used to dissolve polymer (F), and
mixing the two solutions to provide a binder solution (B).

The weight ratio of polymer (F) to polymer (A) in binder (B) is conveniently in the range of from 95:5 to 70:30. In a preferred embodiment of the invention, the weight ratio of polymer (F) to polymer (A) in binder (B) is 90:10.

The electrode-forming composition (C) may be obtained by adding and dispersing a powdery electrode material, and optional additives, such as an electroconductivity-imparting additive and/or a viscosity modifying agent, into the thus-obtained binder solution (B), to obtain a homogeneous slurry.

The solution of polymer (F) in solvent (S) is notably comprising the polymer (F) in an amount of from 5 to 20% by weight, preferably about 7 to 10% by weight.

The solution of polymer (A) in solvent (S) is notably comprising the polymer (A) in an amount of from 5 to 10% by weight in 100 parts by weight of such a solvent.

For obtaining the binder solution (B) comprising polymer (F) and polymer (A) as above detailed, it is preferred to dissolve separately the polymer (F) is solvent (S) and from 5 to 10% by weight of the polymer (A) in 100 parts by weight of such a solvent.

In order to prepare the binder solution (B), it is preferred to dissolve the polymer (F) and polymer (A) in a solvent (S) at a temperature of 20-50° C.

Alternatively, the binder solution (B) can be prepared by first dissolving polymer (F) in solvent (S), followed by addition of solid polymer (A) to the mixture prepared thereof.

The total solid content (TSC) of the composition (C) of the present invention is typically comprised between 15 and 70% by weight, preferably from 40 to 60% by weight over the total weight of the composition (C). The total solid content of the composition (C) is understood to be cumulative of all non-volatile ingredients thereof, notably including polymer (F), polymer (A), the electrode active material and any solid, non-volatile additional additive.

When the solutions of polymer (F) and of polymer (A) are prepared separately and subsequently combined with an electrode active material and optional conductive material and other additives to prepare composition (C), an amount of solvent sufficient to create a stable solution is employed. The amount of solvent used may range from the minimum amount needed to create a stable solution to an amount needed to achieve a desired total solid content in an electrode mixture after the active electrode material, optional conductive material, and other solid additives have been added.

Mixing of the two solutions is carried out by any known method in the art, such as by planetary mixing followed by dispersion phase.

The presence of polymer (A) in the composition (C) makes it possible to obtain homogenous slurry compositions with no gelation evidence in all the preparation steps. Thus, it is possible to use of polymers (F) bearing polar groups in electrode-forming composition comprising the olivine type active material electrodes, and exploiting the properties of such polymers in electrodes, such as the greater adhesion to current collector, the improved flexibility and the good mechanical performances.

In addition, polymer (A) acts as a dispersant in binder compositions, and reduces the slurry viscosity versus compositions having the same TSC but comprising a polymer (F), an active material and an electroconductivity-imparting additive only.

Another advantage of the composition (C) of the present invention is that it is possible to provide an electrode which comprises a relatively low content by weight of binder and to make it possible to increase the content of active material in the positive electrode, in order to maximise the capacity of the battery.

The electrode-forming composition (C) of the invention can be used in a process for the manufacture of a positive electrode [electrode (E)], said process comprising:
(i) providing a metal substrate having at least one surface;
(ii) providing an electrode-forming composition [composition (C)] as above defined;
(iii) applying the composition (C) onto the at least one surface of the metal substrate, thereby providing an assembly comprising a metal substrate coated with said composition (C) onto the at least one surface;
(iv) drying the assembly provided in step (iii).

The metal substrate is generally a foil, mesh or net made from a metal, such as from aluminium, nickel, titanium, and alloys thereof.

In step (iii) of the process of the invention, the electrode forming composition (C) is applied onto at least one surface of the metal substrate typically by any suitable procedures such as casting, printing and roll coating.

Optionally, step (iii) may be repeated, typically one or more times, by applying the electrode forming composition (C) provided in step (ii) onto the assembly provided in step (iv).

In step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

The dried assembly obtained in step (iv) may further be submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 2 and 3 g/cc, preferably at least 2.1 g/cc. The density of electrode (E) is calculated as the sum of the product of the densities of the components of the electrode multiplied by their mass ratio in the electrode formulation.

In a further aspect, the present invention pertains to the electrode [electrode (E)] obtainable by the process of the invention.

Therefore the present invention relates to an electrode (E) comprising:
a metal substrate having at least one surface, and
directly adhered onto at least one surface of said metal substrate, at least one layer consisting of a composition [composition (C′)] comprising:
a) at least one positive electrode active material (AM) having an olivine structure;
b) a binder composition [binder (B′)] comprising:
b′) at least one polymer (F) as above defined,
b″) at least one polymer (A) as above defined;
c) optionally, at least one electroconductivity-imparting additive.

The composition (C′) directly adhered onto at least one surface of said metal substrate corresponds to the electrode forming composition (C) of the invention wherein the solvent has been at least partially removed during the manufacturing process of the electrode, for example in step (iv) (drying) and/or in the further compression step. Therefore all the preferred embodiments described in relation to the electrode forming compositions (C) of the invention are also applicable to the composition (C′) directly adhered onto at least one surface of said metal substrate, in electrodes of the invention, except for the aqueous medium removed during the manufacturing process.

The preferred positive electrode (E) comprises:
a metal substrate having at least one surface, and
directly adhered onto at least one surface of said metal substrate, at least one layer consisting of:
j) a positive electrode active material (AM) having an olivine structure in an amount from 90 to 98% by weight;
jj) the binder (B′) in an amount from 0.5 to 10% by weight, preferably from 1 to 5% by weight; and
jjj an electroconductivity-imparting additive in an amount from 0.5 to 5% by weight,
wherein the above mentioned % by weight are in respect to the total weight of j)+jj)+jjj).

Preferably, the positive electrode (E) comprises of at least 95% by weight of active material (AM) and an electrode loading comprised between 8 and 20 mg/cm², preferably of about 15 mg/cm².

The Applicant surprisingly found that a copolymer [polymer (P)] obtained by radical polymerization of at least one phosphorus-containing unsaturated monomer with acrylic acid and/or methacrylic acid can be advantageously used as primer to provide an outstanding adhesion between the electro active material and the current collector of a cathode.

The Applicant surprisingly found that such good adhesion can be achieved by using a small amount of said polymer (P), so that the electrochemical performances of the final electrode are not negatively affected.

Thus, in another embodiment, the present invention relates to an electrode [electrode (E1)] comprising:
a metal substrate having at least one surface,
a first layer adhered to said at least one surface of said metal substrate, said first layer comprising at least one polymer (P) obtained by radical polymerization of at least one phosphorus-containing unsaturated monomer with acrylic acid and/or methacrylic acid, and
a second layer, adhered to said first layer, comprising at least a composition [composition (C′)] as above defined.

The metal substrate having at least one surface is preferably a surface-modified metal substrate having at least one side that is at least partially chemically modified.

Preferably, said polymer (P) is obtained by radical polymerization of:
at least one phosphorus-containing unsaturated monomer of formula (a) or (b) as represented below:

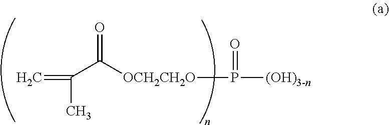

wherein n is 1 or 2;
(b) H₂C═CH—P(═O)—(OH)₂
with acrylic acid and/or methacrylic acid.

Preferably, polymer (P) has a molecular weight of at least 7,500 Da, more preferably from 10 kDa to 1500 kDa, even more preferably from 10 kDa to 150 kDa, notably between 10 kDa and 100 kDa.

According to a preferred embodiment, said polymer (P) is obtained by radical copolymerization of the phosphorus-containing unsaturated monomer of formula (b) above with acrylic acid.

According to this embodiment, the phosphorus-containing unsaturated monomer of formula (b) and the acrylic acid are in a molar ratio from 40:60 to 20:80, preferably 35:65 to 25:75 and even more preferably 30:70.

Preferably, according to this first embodiment, polymer (P) has a molecular weight of from 25 kDa to 85 kDa.

According to another preferred embodiment, said polymer (P) is obtained by radical copolymerization of a mixture of 2-hydroxyethyl methacrylate phosphate, complying with formula (a) above wherein n is 1 and 2, with acrylic acid and methacrylic acid.

More preferably, said polymer (P) is obtained by radical copolymerization of a mixture having the following molar ratio, based on the total quantity of acrylic acid, methacrylic acid and 2-hydroxyethyl methacrylate phosphates of Formula (a):
acrylic acid: from 65 to 90%, preferably from 80 to 90%, more preferably 83-85%,
methacrylic acid: from 5 to 30%, preferably from 5 to 15%, more preferably 11-13%,
2-hydroxyethyl methacrylate phosphates: from 2 to 12%, preferably from 2 to 10%, more preferably from 2 to 6% and even more preferably about 4%.

Preferably, according to this embodiment, polymer (P) has a molecular weight of from 15 kDa to 35 kDa.

Average molecular weights (typically weight average molecular weight) are measured by Size Exclusion Chromatography (SEC).

Advantageously, said first layer comprising polymer (P) has a thickness below 1 μm.

The electrode (E1) can be manufactured by a method comprising:
step (1) of providing a metal substrate having at least one surface; optionally step (1 b) of surface treatment of said at least one surface of said metal substrate to provide a surface-modified metal substrate having at least one side that is at least partially chemically modified;
step (2) of contacting at least one polymer (P) with said at least one surface of said metal substrate, thus providing a first layer;
step (3) contacting an electrode-forming composition [composition (C)] as above defined onto the layer obtained in step (2).

The electrode (E) and the electrode (E1) of the invention are particularly suitable for use in electrochemical devices, in particular in secondary batteries.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### Experimental Section

### Raw Materials

Polymer (F-1): VDF-AA (1.0% by moles) polymer having an intrinsic viscosity of 0.30 I/g in DMF at 25° C.

HSV900: PVDF homopolymer, commercially available from Arkema.

Nano-LFP: LFP P2/C-life C₀₄, density: 3.34 g/cm³, practical specific capacity: 153 mAh/g, commercially available from Johnson Matthey.

Carbon nanotubes: Orgacyl NMPO402. 4% thin multiwall carbon nanotube (MWCNT) in N-Methyl-2-pyrrolidone (NMP) solvent.

AMBN: 2,2′-azobis(2-methylbutyronitrile)

Vim: vinylimidazole

### Molecular Weight Determination

The mass distribution of the polymers was measured by SEC MALS analysis (SEC: Size Exclusion Chromatography—MALLS: Multi-Angle Laser Light Scattering) in order to obtain the real values, expressed in g/mol.

The SEC MALLS analysis was performed with an HPLC chain equipped with 2 detectors:
Differential refractometer RI—the concentration detector
MALLS detector (Multi-Angle Laser Light Scattering)—the mass detector—Ultraviolet detector UV.

For each slice of the chromatograms (for the polymeric species), the software calculates:
the concentration of the polymer, RI signal=constant*dn/dc*concentration
the mass Mi of the slice,
from particular Mi data, the software calculates the mass distribution:
Mw, Mn and polydispersity index Ip=Mw/Mn.

The calculation of the molar masses requires the refractive index increment, dn/dc of the polymer. It is a constant, depending on the nature of the mobile phase, the temperature of the experimental conditions and the wavelength of the laser, among others.

The value “dn/dc” is calculated by the software according the mass recovery of the eluted fraction: for the polymers of the present invention dn/dc is 0.085 mL/g, leading from about 95 to 100% wt. mass recovery.

The molar mass was calculated based on the real Mi points, without any adjustment of the log (M) curve.

Detailed Analysis conditions are as follows:

### Preparation 1 and 2:

Analysis instrument: SEC system with MALLS detector (Mini Dawn TREOS); Agilent Differential Refractometer (RI) and Agilent UV detector (at 254 nm)
Pump: Agilent 1100
Mobile phase: THF with 0.01 M tetrabutylammonium tetrafluoroborate and 100 μL trifluoroacetic acid per kg of eluent
Column (maker, model no.): Agilent Polypore (2*30 cm)+guard column
Temperature: 35° C.
Flow rate: 1.0 mL/min
Injection amount and Sample concentration: 100 μL, 3 mg·mL⁻¹ in the mobile phase.

### Preparation 3 and 4:

Size exclusion chromatography (SEC) samples were diluted in a mobile phase (THF+0.01 M tetrabutylammonium tetrafluoroborate) and filtered (on 0.45 μm Millipore) before analyzing.

The samples were analyzed by SEC equipped with a Multi-Angle Laser
Light Scattering (MALLS) detector accordingly to the conditions below:
Eluant: THF+0.01 M tetrabutylammonium tetrafluoroborate
Flow rate: 1 mL·min⁻¹
Columns: Agilent PL Gel 2*mixed B+1*100 Å+a guard column
Detection: RI (Agilent detector)+MALLS (TRISTAR)
Samples concentration: 0.4 wt % in the mobile phase
Injection volume: 100 μL

### Preparation 1: Polymer (A-1): MMA Homopolymer Solution in DMF Solution

In a 500 mL three necked round bottom flask equipped with a reflux condenser and a mechanical agitation, 15.15 g (0.15 mol) of MMA, 1.37 g (7.12 mmol) of AMBN and 123.63 g of DMF were introduced at room temperature. The mixture was purged with nitrogen for 15 minutes at room temperature and then immersed in an oil bath preheated at 80° C. After stabilizing the temperature at 75° C. in the mass, 85.86 g (0.86 mol) of MMA was added to the reaction mixture over 1 hours using a syringe pump. After completion of the addition, the reaction was let stirring for an additional time of 6 hours. After this final ageing step, the mixture was cooled down to ambient temperature. Finally, a dilution was carried out to bring the product to a solution having solid content of of 34.61%.

A sample was taken for ¹H NMR analysis to determine the MMA monomer conversion (¹H RMN in CDCl₃): >99%

A sample was also taken for molecular weight determination: the sample was diluted in a mobile phase (THF+0.01 M tetrabutylammonium tetrafluoroborate+100 μL trifluoroacetic acid per kg of eluent) and filtered (on 0.45 μm Millipore) before analyzing.

### Results:

M_{n,SEC-MALLS}=21,000 g·mol⁻¹
M_{n,SEC-MALLS}=43,000 g·mol⁻¹
Ð=2.0
   Preparation 2: Polymer (A-2): poly(MMA-co-MAA) copolymer solution in DMF

In a 500 mL three necked round bottom flask equipped with a reflux condenser and a mechanical agitation, 12.47 g (0.12 mol) of MMA, 2.68 g (0.03 mol) of MAA, 1.37 g (7.34 mmol) of AMBN and 123.58 g of DMF were introduced at room temperature. The mixture was purged with nitrogen for 20 minutes at room temperature and then immersed in an oil bath preheated at 80° C. After stabilizing the temperature at 75° C. in the mass, a mixture of 70.7 g (0.71 mol) of MMA and 15.19 g (0.18 mol) of MAA was added to the reaction mixture over 1 hours using a syringe pump. After completion of the addition, the reaction was let stirring for an additional time of 6 hours. After this final ageing step, the mixture was cooled down to ambient temperature. Finally a dilution was carried out to bring the product to a solution having solid content of 29.93%:

A sample was taken for ¹H NMR analysis to determine the MMA and MAA monomer conversions:
MMA monomer conversion (¹H RMN in CDCl₃): >99%
MAA monomer conversion (¹H RMN in CDCl₃): >99%

### Preparation 3: Polymer (A-3): Poly(MMA-Co-VIm) 80:20 Copolymer Solution in NMP

In a 1 L jacketed reactor equipped with a multi-stage lightning A320 stirring blade, counter-blades, a condenser connected to a minichiller and a cryothermostatic bath were introduced, at room temperature, MMA (24.537 g, 0.243 mol), Vim (5.766 g, 0.061 mol), AMBN (2.777 g, 0.014 mol) and 421.379 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (139.040 g, 1.375 mol) and NVI (32.677 g, 0.344 mol) was prepared. Once the temperature of 75° C. was reached in the reactor, the monomer solution, previously prepared, was introduced over 1 hour. After completion of the addition, the reaction was aged at 75° C. for an additional time of 6 hours. The reaction was then cooled down to room temperature and the reactor was discharged.

The monomer conversion was determined by 1H NMR. The number and weight average molar masses (Mₙ and M_{w}) could not be determined by size exclusion chromatography for this copolymer.

### Results:

MMA monomer conversion (¹H RMN in CDCl₃)>99%
VIm monomer conversion (¹H RMN in CDCl₃)>99%
Solid content: 30.38 wt %

### Preparation 4: Polymer (A-4): Poly(MMA-Co-VIm) 95:5 Copolymer Solution in NMP

In a 1 L jacketed reactor equipped with a multi-stage lightning A320 stirring blade, counter-blades, a condenser connected to a minichiller and a cryothermostatic bath were introduced, at room temperature, MMA (28.874 g, 0.286 mol), Vim (1.429 g, 0.015 mol), AMBN (2.751 g, 0.014 mol) and 421.063 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (163.622 g, 1.618 mol) and NVI (8.096 g, 0.085 mol) was prepared. Once the temperature of 75° C. was reached in the reactor, the monomer solution, previously prepared, was introduced over 1 hour. After completion of the addition, the reaction was aged at 75° C. for an additional time of 6 hours. The reaction was then cooled down to room temperature and the reactor was discharged.

The monomer conversion was determined by 1H NMR. The number and weight average molar masses (Mₙ and M_{w}) were determined by size exclusion chromatography.

### Results and Methods:

MMA monomer conversion (¹H RMN in CDCl₃)>99%
VIm monomer conversion (¹H RMN in CDCl₃)>99%
M_{n,SEC-MALLS}=35,000 g·mol⁻¹
M_{n,SEC-MALLS}=51,000 g·mol⁻¹
Ð=1.5
Solid content: 31.54 wt %

### Example 1

A 8% by weight solution of polymer (F-1) in NMP was prepared.

A 8% by weight solution of polymer (A-1) in NMP was prepared starting from the solution of polymer (A-1) in DMF obtained in Preparation 1 above: polymer (A-1) in powder form was precipitated from the solution in DMF in distilled water and the obtained precipitate was dried in vacuum oven overnight at 90° C. The powder of polymer (A-1) so obtained was dissolved at 8% by weight in NMP.

The solution of polymer (F-1) in NMP and the solution of polymer (A-1) in NMP were mixed in a 9:1 ratio (30.87 g of solution of polymer (F-1) and 3.43 g of solution of polymer (A-1)).

Nano-LFP (75.07 g), carbon nanotubes (14.7 g of solution at 4% wt in NMP) and additional 15.94 g of NMP were added to the solution comprising polymer (F-1) and polymer (A-1) with planetary mixing followed by dispersion phase to provide COMPOSITION 1, a cathode slurry having a Total Solid Content (TSC) of 56% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Example 2

A 8% by weight solution of polymer (F-1) in NMP was prepared.

A 8% by weight solution of polymer (A-2) in NMP was prepared starting from the solution of polymer (A-2) in DMF obtained in Preparation 2 above: polymer (A-2) in powder form was precipitated in distilled water and the obtained precipitate was dried in vacuum oven overnight at 90° C. The powder of polymer (A-2) so obtained was dissolved at 8% by weight in NMP.

The solution of polymer (F-1) in NMP and the solution of polymer (A-2) in NMP were mixed in a 9:1 ratio (30.87 g of solution of polymer (F-1) and 3.43 g of solution of polymer (A-2)).

Nano-LFP (75.07 g), carbon nanotubes (14.7 g of solution at 4% wt in NMP) and additional 15.94 g of NMP were added to the solution comprising polymer (F-1) and polymer (A-2) with planetary mixing followed by dispersion phase to provide COMPOSITION 2, a cathode slurry having a Total Solid Content (TSC) of 56% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Example 3

A 8% by weight solution of polymer (F-1) in NMP was prepared.

A 8% by weight solution of polymer (A-2) in NMP was prepared starting from the solution of polymer (A-2) in DMF obtained in Preparation 2 above: polymer (A-2) in powder form was precipitated from the solution in DMF in distilled water and the obtained precipitate was dried in vacuum oven overnight at 90° C. The powder of polymer (A-2) so obtained was dissolved at 8% by weight in NMP.

The solution of polymer (F-1) in NMP and the solution of polymer (A-2) in NMP were mixed in a 9:1 ratio (13.3 g of solution of polymer (F-1) and 1.47 g of solution of polymer (A-2)).

Nano-LFP (76.64 g), carbon nanotubes (14.7 g of solution at 4% wt in NMP) and additional 33.97 g of NMP were added to the solution comprising polymer (F-1) and polymer (A-2) with planetary mixing followed by dispersion phase to provide COMPOSITION 3, a cathode slurry having a Total Solid Content (TSC) of 56% (97.5% LFP, 1% carbon nanotubes and 1.5% binder).

A homogenous slurry was obtained, with no gelation evidence in all the preparation steps.

### Example 4

A 8% by weight solution of polymer (F-1) in NMP was prepared.

A 8% by weight solution of polymer (A-3) in NMP was prepared starting from the solution of polymer (A-3) in NMP obtained in Preparation 3 above.

The solution of polymer (F-1) in NMP and the solution of polymer (A-3) in NMP were mixed in a 9:1 ratio (30.87 g of solution of polymer (F-1) and 3.43 g of solution of polymer (A-3)).

Nano-LFP (75.07 g), carbon nanotubes (14.7 g of solution at 4% wt in NMP) and additional 15.94 g of NMP were added to the solution comprising polymer (F-1) and polymer (A-3) with planetary mixing followed by dispersion phase to provide COMPOSITION 4, a cathode slurry having a Total Solid Content (TSC) of 56% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Example 5

A 8% by weight solution of polymer (F-1) in NMP was prepared.

A 8% by weight solution of polymer (A-4) in NMP was prepared starting from the solution of polymer (A-4) in DMF obtained in Preparation 4 above.

The solution of polymer (F-1) in NMP and the solution of polymer (A-4) in NMP were mixed in a 9:1 ratio (30.87 g of solution of polymer (F-1) and 3.43 g of solution of polymer (A-4)).

Nano-LFP (75.07 g), carbon nanotubes (14.7 g of solution at 4% wt in NMP) and additional 15.94 g of NMP were added to the solution comprising polymer (F-1) and polymer (A-4) with planetary mixing followed by dispersion phase to provide COMPOSITION 5, a cathode slurry having a Total Solid Content (TSC) of 56% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Comparative Example 1

A 8% by weight solution of HSV900 in NMP was prepared.

Nano-LFP (75.07 g), carbon nanotubes (14.7 g of solution at 4% wt in NMP) and additional 15.94 g of NMP were added to 34.3 g of the solution comprising HSV900 with planetary mixing followed by dispersion phase to provide COMPOSITION (C-1), a cathode slurry having a Total Solid Content (TSC) of 56% and an amount of binder of 3.5%.

Results of visual evaluation of slurry quality are summarized at Table 1.

### Comparative Example 2

A 8% by weight solution of polymer (F-1) in NMP was prepared.

Nano-LFP (75.07 g), carbon nanotubes (14.7 g of solution at 4% wt in NMP) and additional 15.94 g of NMP were added to 34.3 g of the solution comprising polymer (F-1) with planetary mixing followed by dispersion phase to provide COMPOSITION (C-2), a cathode slurry having a Total Solid Content (TSC) of 56% and an amount of binder of 3.5%.

Results of visual evaluation of slurry quality are summarized at Table 1.

### Comparative Example 3

A 8% by weight solution of polymer (A-1) in NMP was prepared starting from the solution of polymer (A-1) in DMF obtained in Preparation 1 above: polymer (A-1) in powder form was precipitated from the solution in DMF in distilled water and the obtained precipitate was dried in vacuum oven overnight at 90° C.

The powder of polymer (A-1) so obtained was dissolved at 8% by weight in NMP.

Nano-LFP (75.07 g), carbon nanotubes (14.7 g of solution at 4% wt in NMP) and additional 15.94 g of NMP were added to 34.3 g of the solution comprising polymer (A-1) with planetary mixing followed by dispersion phase to provide COMPOSITION (C-3), a cathode slurry having a Total Solid Content (TSC) of 56% and an amount of binder of 3.5%.

Results of visual evaluation of slurry quality are summarized at Table 1.

### Comparative Example 4

A 8% by weight solution of polymer (A-2) in NMP was prepared starting from the solution of polymer (A-2) in DMF obtained in Preparation 2 above: polymer (A-2) in powder form was precipitated from the solution in DMF in distilled water and the obtained precipitate was dried in vacuum oven overnight at 90° C. The powder of polymer (A-2) so obtained was dissolved at 8% by weight in NMP.

Nano-LFP (75.07 g), carbon nanotubes (14.7 g of solution at 4% wt in NMP) and additional 15.94 g of NMP were added to 34.3 g of the solution comprising polymer (A-2) with planetary mixing followed by dispersion phase to provide COMPOSITION (C-4), a cathode slurry having a Total Solid Content (TSC) of 56% and an amount of binder of 3.5%.

Results of visual evaluation of slurry quality are summarized at Table 1.

TABLE 1

| COMPOSITION | Slurry Quality* |
|---|---|
| 1 | B |
| 2 | A |
| 3 | A |
| 4 | A |
| 5 | A |
| C-1 | A |
| C-2 | C |
| C-3 | B |
| C-4 | B |

*A = good: visual homogeneous aspect at rest and under manual stirring. No evidence of agglomerates, nor phase separation, nor deposits on the container's walls.
B = medium: the slurry seems homogenous. Evidence of small agglomerates, e.g. solid particles not perfectly dispersed, small gels or thin deposit on the bottom or on the walls of the becker. Slurry casting not prevented.
C = bad: not homogeneous slurry, with macroscopic evidences. Gels or solid agglomerates are present. Slurry viscosity can be too high to allow casting and further mixing can be prevented/limited due to solid block (gel-like) formation. If phase separation happens, too low viscosity in the upper part and solid bottom layer.

### Example 6: Electrode-Forming Compositions Gelation Evaluation

Viscosity variation over time of Compositions 2 and (C-1) prepared as above defined was evaluates as follows.

The viscosity of the compositions at different aging times, up to 72 hours, was evaluated at different shear rate (from 0.1 to 100 rad/s), by comparing the values at the same share rate with an Anton Paar instrument with MCR 52 plate to plate configuration.

The results are reported in Table 2.

TABLE 2

| | Viscosity variation over time*** | | | | | |
|---|---|---|---|---|---|---|
| Composition | T = 0 h | T = 1.5 h | T = 3 h | T = 24 h | T = 48 h | T = 72 h |
| (2) | 1 | 1.5 | 1.85 | 2.6 | 3.25 | 2.9 |
| (C-1) | 1 | 0.96 | 0.95 | 2.75 | 3.1 | 4.8 |

***normalized vs t₀ viscosity

In view of the above, it has been found that positive electrode-forming compositions (C) according to the present invention, thanks to the presence of the binder (B) including polymer (A) are characterized by an improved resistance to gelation.

### Example 7: Preparation of electrodes

Positive electrodes were obtained by applying the electrode-forming COMPOSITIONS 1 to 5 and COMPOSITIONS (C-1) to (C-4) as above described to 15 μm thick aluminium foils so as to obtain a mass of dry positive electrode loading of 15 mg/cm². The solvent was completely evaporated by drying in an oven at temperature of 90° C. to fabricate a strip-shaped positive electrodes.

The positive electrodes so obtained (electrode (E1), (E2), (E4), (E5) (EC-1), (EC-2), (EC-3) and (EC-4), respectively) were visually evaluated. The results are reported in Table 3.

TABLE 3

| ELECTRODE | COMPOSITION | Electrode quality** |
|---|---|---|
| E1 | 1 | B |
| E2 | 2 | A |
| E3 | 3 | A |
| E4 | 4 | A |
| E5 | 5 | A |
| EC-1 | C-1 | A |
| EC-2 | C-2 | n.d. |
| EC-3 | C-3 | C |
| EC-4 | C-4 | C |

**A = good: smooth aspect, no evidence of agglomerates on the dried electrode, nor inhomogeneity due to bubbles formation and evaporation. Manual handling was easy, electrodes have good flexibility when slightly bended and folded, with no evidence of active material cracking or detachment.
B = medium: electrodes have an average homogeneous aspect. With accurate visual observation or with optical microscope, small agglomerates are detected. No material detachment nor cracking with gentle bending
C = bad: macroscopic inhomogeneity on the electrode surface (e.g. solid particles dragged during casting). Material cracked or detached from current collector without handling. Not possible to be punched/cut for further characterization

### Example 8: Preparation of electrodes with primer

An Al current collectors was subjected to etching with 5 wt. % HNO₃ solution, for 4 minutes at 40° C.

Then, it was dip coated with a solution of polymer (P)-1, which is a random copolymer obtained from copolymerization of a mixture of acrylic acid and vinyl phosphoric acid, in a molar ratio 70:30. Polymer (P)-1 had a weight average molecular weight (Mw) in the range from about 30 to 80 kDa, as measured by GPC using the following conditions: SEC was equipped with a MultiAngle Laser Light Scattering (MALLS) Mini Dawn TREOS detector and an Agilent concentration detector (RI detector). The SEC-MALLS system run on three columns Varian Aquagel OH mixed H, 8 μm, 3*30 cm at a flow rate of 1 mL/min and with the following mobile phase: 100% water, NaCl 100 mM, NaH₂PO₄ 25 mM, Na₂HPO₄ 25 mM buffer solution pH=7. Polymer samples were diluted down to 0.5 active wt % in the mobile phase for at least 4 hours then filtered in a Millipore filter 0.45 μm and 100 microliters were injected in the mobile phase flow. Absolute molar masses were obtained with the dn/dC of the poly(acrylic acid) equal to 0.1875 mL/g. As detector, the following was used: RI (Agilent concentration detector)+MALLS (MultiAngle Laser Light Scattering) Mini Dawn TREOS.

The dipping was performed for 2 minutes at 45° C. Then, rinsing was performed, followed by drying for 5 minutes starting from room temperature up to 100° C.

A suitable amount of COMPOSITION 2 was casted on the treated Al current collector and then drying was performed.

The positive electrode (E6) was obtained.

### Positive Electrodes Adhesion Evaluation

Positive electrodes (E2), (E3) and (EC-1) were cut in stripes (10 cm long and 2.5 cm wide) and applied onto rigid aluminium foils having thickness of 2 mm, using a biadhesive tape of dimensions 2.5×8 cm, with the coated side of the electrode facing the aluminium plate. A portion of the electrode was kept from adhering to the tape, thus leaving one end of each stripe not in contact with the biadhesive tape, allowing for its pulling from the foil.

Each specimen was pulled from the foil at an angle of 180° by a dynamometer that allowed the measurement of the force needed to peel off the sample from the biadhesive tape. Peeling speed is 300 mm/min, with T=25° C. The results are summarized in Table 4.

TABLE 4

| | Peeling Strength |
|---|---|
| | (N/m)**** |
| E2 | 14 |
| E3 | 5 |
| EC-1 | 1 |

****Normalized to EC-1

### Positive Electrodes Adhesion Evaluation

Positive electrodes (E2), (E4), (E5) and (E6) were cut in stripes (10 cm long and 2.5 cm wide) and applied onto rigid aluminium foils having thickness of 2 mm, using a biadhesive tape of dimensions 2.5×8 cm, with the coated side of the electrode facing the aluminium plate. A portion of the electrode was kept from adhering to the tape, thus leaving one end of each stripe not in contact with the biadhesive tape, allowing for its pulling from the foil.

Each specimen was pulled from the foil at an angle of 180° by a dynamometer that allowed the measurement of the force needed to peel off the sample from the biadhesive tape. Peeling speed is 300 mm/min, with T=25° C. The results are summarized in Table 5.

TABLE 5

| | Peeling Strength |
|---|---|
| | (N/m)**** |
| E2 | 1 |
| E4 | 1.34 |
| E5 | 1.49 |
| E6 | 1.24 |

*****Normalized to E2

It has been demonstrated that the electrodes of the invention have an improved adhesion to metal foil in comparison with standard electrodes of the prior art comprising PVDF.

1. A positive electrode-forming composition (C) comprising at least one positive electrode active material (AM) having an olivine structure and at least one binder (B), wherein binder (B) consists of:
a) at least one vinylidene fluoride (VDF) copolymer [polymer (F)] that comprises:
(i) recurring units derived from VDF;
(ii) recurring units derived from at least one hydrophilic (meth)acrylic monomer (MA) of formula (I): 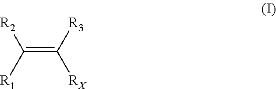
wherein:
R₁, R₂ and R₃, equal to or different from each other, are independently selected from a hydrogen atom and a C₁-C₃ hydrocarbon group, and
Rₓ is a C₁-C₂₀ hydrocarbon moiety comprising at least one functional group selected from a hydroxyl, a carboxyl, an epoxide, an ester and an ether group, in an amount of from 0.05 to 10% by moles of with respect to the total moles of recurring units of polymer (F);
b) at least one a (meth)acrylic polymer [polymer (A)];
c) at least one solvent [solvent (S)]; and
d) optionally at least one electroconductivity-imparting additive.

2. The composition (C) according to claim 1, wherein the hydrophilic (meth)acrylic monomer (MA) is selected from the group consisting of acrylic acid, methacrylic acid, hydroxyethyl (meth)acrylate, hydroxypropyl(meth)acrylate; hydroxyethylhexyl(meth)acrylate.

3. The composition (C) according to claim 1, wherein the active material (AM) has the following formula:
LiₓA_{y}D_{z}PO₄,
wherein A is selected from the group consisting of Mn, Fe, Co, Ni and Cu; D is selected from the group consisting of Mg, Ca, Sr, Ba; x, y and z are numbers that satisfy the following relationships: 0<x<2, 0<y<1.5, 0≤z<1.5.

4. The composition according to claim 1, wherein the active material (AM) is lithium iron phosphate (LFP).

5. The composition (C) according to claim 1, wherein polymer (A) comprises recurring units derived from at least one (meth)acryloyl monomer (MAM) selected from the group consisting of (meth)acrylamide acid esters of formula CH₂═C(R)—C(═O)—NH—Rh, or (meth)acrylic acid esters of formula CH₂═C(R)—C(═O)—O—Rh wherein R means hydrogen or an alkyl group with 1 to 3 carbon atoms and Rh means a linear or branched alkyl residue with 1 to 30 carbon atoms.

6. The composition (C) according to claim 5, wherein the at least one (meth)acryloyl monomer (MAM) is selected from the group consisting of methyl (meth)acrylate, ethyl (meth)acrylate, n-propyl(meth)acrylate, isopropyl(meth)acrylate, n-butyl (meth)acrylate, methoxy ethyl (meth)acrylate, 2-ethoxy ethyl (meth)acrylate, tert-butyl (meth)acrylate, pentyl(meth)acrylate, heptyl(meth)acrylate, 2-tert-butylheptyl(meth)acrylate, octyl (meth)acrylate), iso-octyl(meth)acrylate, nonyl(meth)acrylate, decyl(meth)acrylate, undecyl(meth)acrylate, 5-methylundecyl(meth)acrylate, dodecyl (meth)acrylate, isobornyl (meth)acrylate, norbornyl(meth)acrylate, cycloalkyl (meth)acrylate, like cyclohexyl(meth)acrylate, phenyl (meth)acrylate.

7. The composition (C) according to claim 1, wherein polymer (A) further comprises recurring units derived from at least one hydrophilic (meth)acryloyl monomer selected from the group consisting of acrylic acid, methacrylic acid (MAA), hydroxyethyl(meth)acrylate, hydroxypropyl(meth)acrylate, hydroxyethylhexyl(meth)acrylate, crotonic acid, 2-carboxyethyl acrylate oligomers such as Sipomer®B-CEA or recurring units derived from one or more ethylenically unsaturated monomer carrying an unsaturated heterocyclic group having at least one nitrogen atom [monomer (M1)] having the formula (III) below: 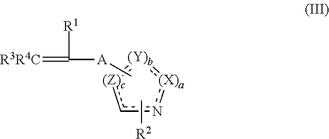
wherein:
R¹ is H or an alkyl group, wherein the alkyl group is preferably a methyl group;
R² is H or an alkyl group;
R³ and R⁴ being the same or different from each other, may be selected from a hydrogen atom or from a linear or branched alkyl group having 1 to 6 carbon atoms;
A is a linkage selected from the group consisting of:
a single covalent bond; and
a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond.

8. The composition (C) according to claim 7, wherein the monomer (M1) is selected from the group consisting of:

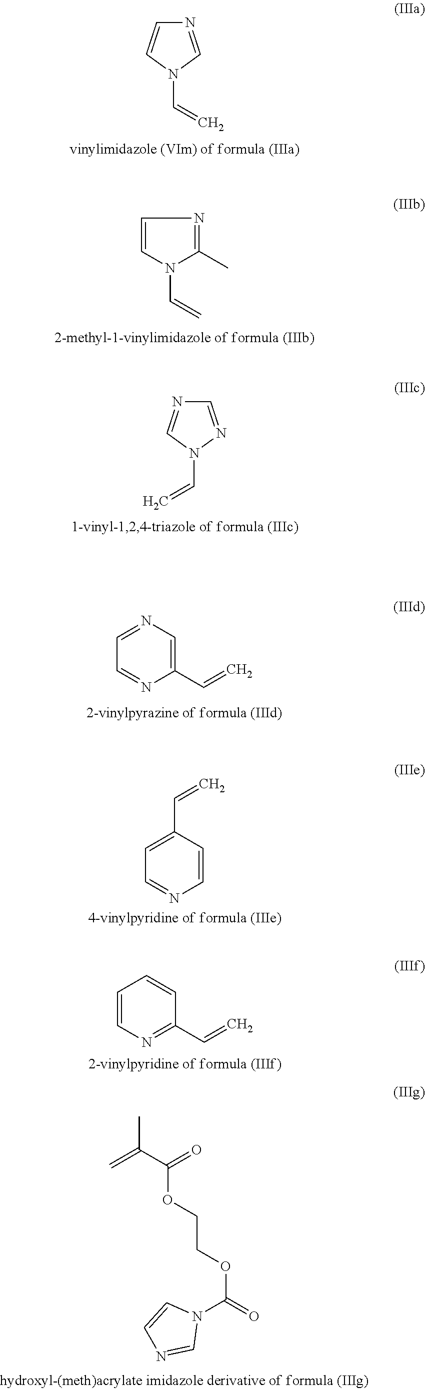

9. The composition (C) according to claim 1, wherein polymer (A) is a methylmethacrylate polymer that contains at least 50% by weight of methylmethacrylate monomer units.

10. The composition (C) according to claim 9, wherein polymer (A) is a methylmethacrylate polymer comprising 100% by weight of methylmethacrylate monomer units.

11. The composition (C) according to claim 9, wherein is a methylmethacrylate polymer comprising at least 80% by weight of methylmethacrylate monomer units and up to 20% by weight of methacrylic acid monomer units.

12. The composition (C) according to claim 1, wherein polymer (A) is at least partially salified.

13. The composition (C) according to claim 1, wherein the weight ratio of polymer (F) to polymer (A) in binder (B) is in the range of from 95:5 to 70:30.

14. A process for the manufacture of a positive electrode [electrode (E)], said process comprising:
(i) providing a metal substrate having at least one surface;
(ii) providing an electrode-forming composition [composition (C)] according to claim 1;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii).

15. A positive electrode (E) obtained by the process according to claim 14.

16. A positive electrode (E), which comprises:
a metal substrate having at least one surface, and
directly adhered onto at least one surface of said metal substrate, at least one layer consisting of:
j) a positive electrode active material (AM) having an olivine structure in an amount from 90 to 98% by weight;
jj) a binder (B′) that comprises
b′) at least one vinylidene fluoride (VDF) copolymer [polymer (F)] that comprises:
(i) recurring units derived from VDF;
(ii) recurring units derived from at least one hydrophilic (meth)acrylic monomer (MA) of formula (I): 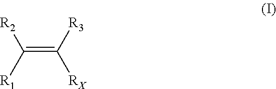
wherein:
R₁, R₂ and R₃, equal to or different from each other, are independently selected from a hydrogen atom and a C₁-C₃ hydrocarbon group, and
Rₓ is a C₁-C₂₀ hydrocarbon moiety comprising at least one functional group selected from a hydroxyl, a carboxyl, an epoxide, an ester and an ether group,
in an amount of from 0.05 to 10% by moles of with respect to the total moles of recurring units of polymer (F);
b″) at least one a (meth)acrylic polymer [polymer (A)]; and
optionally at least one electroconductivity-imparting additive,
said binder (B′) being in an amount from 0.5 to 10% by weight; and
jjj) an electroconductivity-imparting additive in an amount from 0.5 to 5% by weight,
wherein the above mentioned % by weight are in respect to the total weight of j)+jj)+jjj).

17. An electrochemical device comprising the electrode (E) according to claim 16.

18. The composition (C) according to claim 1, wherein polymer (A) is a methylmethacrylate polymer that contains at least 70% by weight of methylmethacrylate monomer units.

19. The composition (C) according to claim 1, wherein polymer (A) is a methylmethacrylate polymer that contains at least 80% by weight of methylmethacrylate monomer units.

20. The composition (C) according to claim 1, wherein the weight ratio of polymer (F) to polymer (A) in binder (B) is 90:10.
